(19) United States
(12) Patent Application Publication
(10) Pub. No.: US 2018/0365004 A1
(43) Pub. Date: Dec. 20, 2018

(54) METHOD AND DEVICE FOR CALLING SOFTWARE DEVELOPMENT KIT

(71) Applicant: BEIJING XIAOMI MOBILE SOFTWARE CO., LTD., Beijing (CN)

(72) Inventors: Yinli CHEN, Beijing (CN); Wei TONG, Beijing (CN); Hongguang DONG, Beijing (CN); Liang YANG, Beijing (CN); Shun CHEN, Beijing (CN)

(73) Assignee: BEIJING XIAOMI MOBILE SOFTWARE CO., LTD., Beijing (CN)

(21) Appl. No.: 15/995,422

(22) Filed: Jun. 1, 2018

(30) Foreign Application Priority Data
Jun. 14, 2017 (CN) 201710448243.5

(51) Int. Cl. G06F 8/70; G06F 21/64; G06F 9/54

(52) U.S. Cl. CPC G06F 8/70; G06F 9/541; G06F 21/645

(57) ABSTRACT

The present disclosure relates to a method for calling a software development kit. The method is applied in a platform and includes: according to a received preset instruction, triggering a target application to call a software development kit of a third-party application, where the target application runs on the platform; transmitting identification information of the target application to the software development kit; determining metadata which is required for the third-party application to verify the target application, and establishing an association relationship between the metadata and the identification information; and registering the metadata into a system where the platform is in so that the third-party application performs verification by obtaining the metadata associated with the identification information according to the association relationship.

This application is based upon and claims priority to Chinese Application No. 201710448243.5, filed Jun. 14, 2017, the entire content of which is incorporated herein by reference for all purposes.

### TECHNICAL FIELD

The present disclosure relates to the terminal technologies, and more particularly, to a method, a device and a computer-readable storage medium for calling a software development kit.

### BACKGROUND

When an application in an electronic device calls a Software Development Kit (SDK) of a third-party application, the third-party application needs to verify the application.

Generally, the software development kit of the third-party application obtains data relating to the application to perform verification. However, in some cases, the software development kit of the third-party application cannot obtain the data relating to the application during the verification, thereby resulting in failed verification. As a result, the calling of the software development kit of the third-party cannot be completed.

### SUMMARY

The present disclosure provides a method, a device and a non-transitory computer-readable medium for calling a software development kit.

According to a first aspect of the present disclosure, there is provided a method for calling a software development kit, applied in a platform. The method may include: according to a received preset instruction, triggering a target application to call a software development kit of a third-party application, where the target application runs on the platform; transmitting identification information of the target application to the software development kit; determining metadata which is required for the third-party application to verify the target application, and establishing an association relationship between the metadata and the identification information; and registering the metadata into a system where the platform is in so that the third-party application performs verification by obtaining the metadata associated with the identification information according to the association relationship.

According to a second aspect of the present disclosure, there is provided a device. The device may include: a processor; and a memory for storing instructions executable by the processor; where the processor is configured to: according to a received preset instruction, trigger a target application to call a software development kit of a third-party application, where the target application runs on the platform; transmit identification information of the target application to the software development kit; determine metadata which is required for the third-party application to verify the target application, and establish an association relationship between the metadata and the identification information; and register the metadata into a system where the platform is in so that the third-party application performs verification by obtaining the metadata associated with the identification information according to the association relationship.

According to a third aspect of the present disclosure, there is provided a computer-readable storage medium having stored therein computer programs that, when the computer programs are executed by a processor, the computer programs may cause the processor to implement: according to a received preset instruction, triggering a target application to call a software development kit of a third-party application, where the target application runs on the platform; transmitting identification information of the target application to the software development kit; determining metadata which is required for the third-party application to verify the target application, and establishing an association relationship between the metadata and the identification information; and registering the metadata into a system where the platform is in so that the third-party application performs verification by obtaining the metadata associated with the identification information according to the association relationship.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the present disclosure.

FIG. 1 is a flow chart schematically showing a method for calling a software development kit according to an example.

FIG. 2 is a flow chart schematically showing a method for calling a software development kit according to another example.

FIG. 3 is a flow chart schematically showing a method for calling a software development kit according to another example.

FIG. 4 is a flow chart schematically showing a method for calling a software development kit according to another example.

FIG. 5 is a block diagram schematically showing a device for calling a software development kit according to another example.

FIG. 6 is a block diagram schematically showing a device for calling a software development kit according to another example.

FIG. 7 is a block diagram schematically showing a device for calling a software development kit according to another example.

FIG. 8 is a block diagram schematically showing a device for calling a software development kit according to another example.

### DETAILED DESCRIPTION

Reference will now be made in detail to examples, examples of which are illustrated in the accompanying drawings. The following description refers to the accompanying drawings in which the same numbers in different drawings represent the same or similar elements unless otherwise represented. The implementations set forth in the following description of examples do not represent all implementations consistent with the present disclosure. Instead, they are merely examples of apparatuses and methods consistent with aspects related to the present disclosure as recited in the appended claims.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” and the like may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

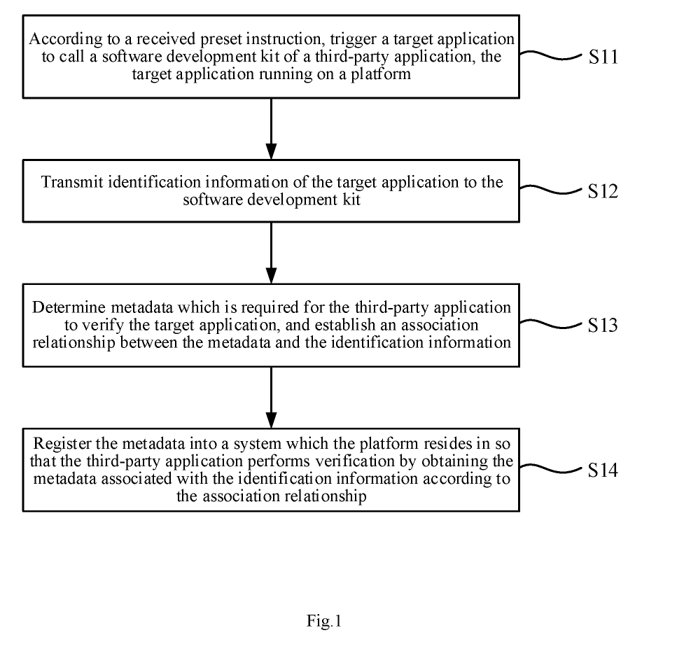

FIG. 1 is a flow chart schematically showing a method for calling a software development kit according to an example. The method is applied in a platform which can be installed in a system. The system may be an operating system of an electronic device such as a terminal, a tablet and the like. As shown in FIG. 1, the method may include the following steps.

In step S11, according to a received preset instruction, a target application is triggered to call a software development kit of a third-party application. The target application runs on the platform.

In an example, applications (including the target application) may run on the platform. The platform provides a running environment for the applications. Further, the platform itself may be an application. On the interface of the platform, identifiers of applications running on the platform can be displayed for user's operation.

Sometimes, the platform may be a software platform. A software platform may be a software environment that is used to write applications and run them. It may include software tools such as GUI builders, compilers, class libraries and utilities for developing the applications, as well as a runtime engine for executing the applications, because they are not able to run on their own.

In an example, for applications which may run on the platform, if a user needs to use a new application, he or she may tap or click a particular link on a web page, or tap or click an icon of the application on the interface of the platform, to trigger the platform to download data relating to the application and install the download data into a process of the platform. The download and installation can be performed at the background. During this procedure, the user does not need to select to download or install, and he or she only needs to perform a tap or click operation to run the application.

In an example, the preset instruction and the third-party application may vary depending on the services provided by the target application. For example, if the target application is a foodservice type application, the present instruction may be a payment instruction and the third-party application may be a payment application. By calling the software development kit of the third-party application, payment can be performed for an order in the foodservice type application. As another example, if the target application is a photographing application, the preset instruction may be a sharing instruction and the third-party application may be a social application. By calling the software development kit of the third-party application, the pictures in the photographing application can be shared.

In step S12, identification information of the target application is transmitted to the software development kit.

In an example, when the user runs the target applications, the identification information can be determined according to the identifier of the target application which is triggered to run, and then the identification information of the target application can be transmitted to the software development kit. The identification information may be data which can be used to determine the identity of the target application, for example, the name or signature of the target application.

In step S13, metadata which is required for the third-party application to verify the target application is determined, and an association relationship between the metadata and the identification information is established.

In step S14, the metadata is registered into a system which the platform resides in so that the third-party application performs verification by obtaining the metadata associated with the identification information according to the association relationship.

In an example, when an application calls a software development kit of a third-party application, the software development kit of the third-party may verify the application (i.e., the target application) which initiates the calling. The verification involves obtaining of metadata registered in the system by the application. For different target applications and software development kits of different third-party applications, the metadata which needs to be obtained for verification is different. For example, if a foodservice application calls a software development kit corresponding to a payment function of a payment application, the metadata which is required for verification may include the name, the signature or the version information of the kit. If the software development kit corresponding to a sharing function of a photographing application needs to be called, the metadata which is required for verification may include the name and the signature of the kit.

The target application in the examples of the present disclosure may be not directly installed in the system or directly run in the system, but run on the platform and thus the metadata of the target application is not registered in the system. Accordingly, depending on software development kits of varying third-party applications and varying target applications, the metadata which is required for the software development kits of the third-party application to verify the target applications can be determined, and the determined metadata can be registered in the system which the platform resides in. This can ensure that the software development kits of the third-party applications can obtain, from the system, the metadata which is required for verification according to identification information to perform verification and thus the software development kits of the third-party applications can be smoothly called.

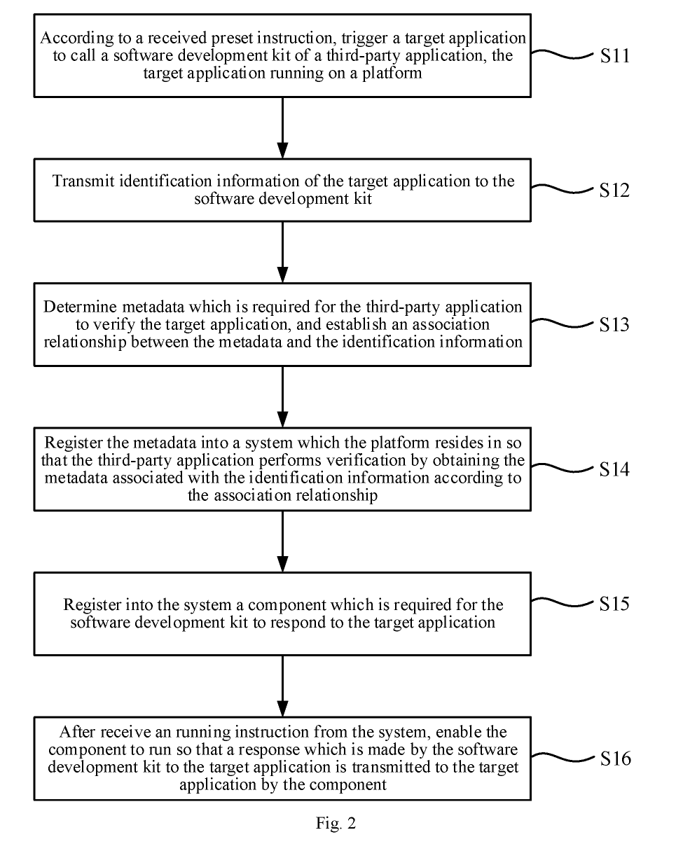

FIG. 2 is a flow chart schematically showing a method for calling a software development kit according to another example. As shown in FIG. 2, on the basis of the examples described with reference to FIG. 1, the method may further include the following steps.

In step S15, a component which is required for the software development kit to respond to the target application is registered into the system.

In step S16, after receiving an running instruction from the system, the component runs so that a response which is made by the software development kit to the target application is transmitted to the target application by the component.

In an example, if the target application passes the verification performed by the software development kit of the third-party application, the software development kit of the third-party responds to the target application. To respond, a component is needed to transmit the response to the target application, so that the target application can know that the software development kit of the third-party application has responded to the calling. The target application in examples of the present disclosure may be not directly installed in the system, but may run on the platform, and thus the component which forwards the response to the target application is not registered in the system.

Thus, the component which is needed to transmit the response which is made by the software development kit of the third-party application to the target application may be registered into the system. This can ensure that when the system receives from the software development kit a request for calling a corresponding component, the existence of the component and the position where the component is located can be determined according to the registered information, thereby triggering the platform to enable the component to run. In this way, the response made by the software development kit to the target application can be transmitted to the target application by the component, so that the target application can know that the software development kit of the third-party application which the target application calls has responded. Thus, the whole calling procedure is completed.

In an example, depending on varying target applications and software development kits of varying third-party applications, the plug which is used to forward the response made by the software development kit of the third-party applications to the target applications can be different. For example, in Android, the component may be the Activity component or the Service component, or other components to name a few. Specific component can be determined according to actual situations.

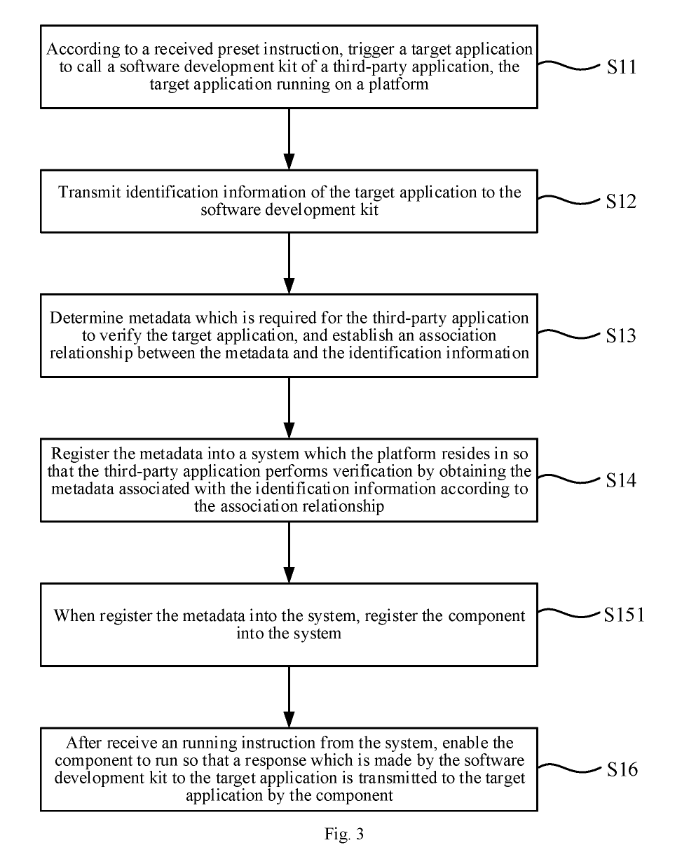

FIG. 3 is a flow chart schematically showing a method for calling a software development kit according to an example. As shown in FIG. 3, on the basis of the examples shown in FIG. 2, the step of registering into the system a component which is required for the software development kit to respond to the target application includes the following step S151.

In step S151, when registering the metadata into the system, the component is registered into the system.

In an example, when the metadata is registered into the system which the platform resides in, the component is also registered into the system. In this way, the registrations can be performed together, thereby simplifying the operations during the calling procedure.

In an example, the metadata and component may be stored in a process in the platform or a process in the system.

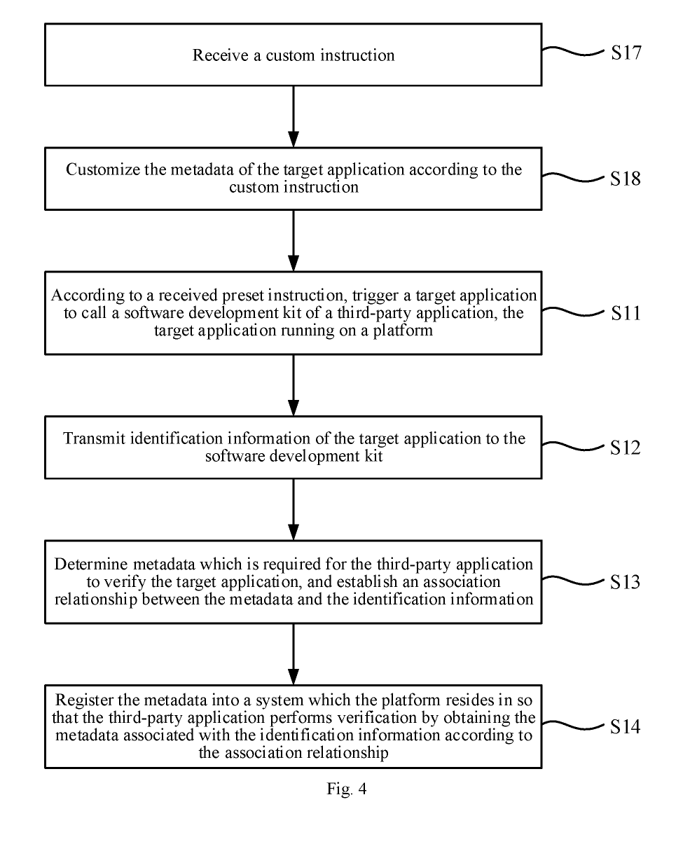

FIG. 4 is a flow chart schematically showing a method for calling a software development kit according to another example. As shown in FIG. 4, on the basis of the example described with reference to FIG. 1, prior to the receiving of the preset instruction, the method further includes the following steps.

In step S17, a custom instruction is received.

In step S18, the metadata of the target application is customized according to the custom instruction.

In an example, the metadata which is needed for the software development kits of different third-party applications to verify the target applications may be different, and thus the platform may provide a function for customizing the metadata, so that the users or software engineers responsible for debugging may input a custom instruction and the metadata of the target application may be customized according to the custom instruction. The number, type or value of the metadata of the target application can be customized to ensure that the requirements when the software development kits of different third-party applications verify the target application can be met, and that the software development kits of the third-party applications can be successfully called.

The following provides exemplary descriptions about the main steps performed in the above examples as a whole.

In an example, when a user calls a function of a third-party application using a target application running in the above-described platform, this triggers the target application to call the software development kit of the third-party application. For example, if the target application is a foodservice type application and the third-party application is a payment application, when the foodservice type application calls the payment function of the payment application, this triggers the foodservice type application to call the software development kit of the corresponding payment in the payment application.

The software development kit needs to verify the target application to confirm whether to allow the target application. Generally, the software development kit verifies the target application by obtaining some metadata of the target application from the system which the target application resides in. However, in the examples of the present disclosure, the target application is not directly installed in the system and does not directly run in the system, but runs on the platform, and the metadata of the target application is not registered in the system.

Thus, on the one hand, the identification information of the target application can be transmitted to the software development kit of the third-party application, and on the other hand the metadata which is needed for the software development kit of the third-party application to verify the target application can be determined according to the software development kit and the target application, and the determined metadata can be registered into the system. In this way, when the software development kit of the third-party application performs verification, the software development kit may, according to the received identification information, inquire the registered information about the metadata of the target application which is related to the identification information, and confirm that the metadata which is needed for the verification exists and thereby allow the calling.

After the verification is passed, the software development kit of the third-party application also needs to respond to the target application. Generally, the response is transmitted to the target application by a component. However, in the examples of the present disclosure, the target application is not directly installed in the system and does not directly run in the system, but runs on the platform, and the component is not registered in the system.

Thus, the component which is needed for the software development kit of the third-party application to respond to the target application can be registered into the system. In this way, when the software development kit of the third-party application sends a request for calling a component, the system can confirm that the component exists according to the registered information, and trigger the platform to enable the component to run. As such, the response made by the software development kit to the target application is transmitted to the target application by the component, and thereby the whole calling procedure is completed.

In correspondence to the examples of the methods for calling a software development kit as described above, the present disclosure also provides examples of the devices for calling a software development kit.

FIG. 5 is a block diagram schematically showing a device for calling a software development kit according to an example. As shown in FIG. 5, the device may include a calling module 51, a transmission module 52, an association module 53 and a metadata registering module 54.

The calling module 51 is configured to, according to a received preset instruction, trigger a target application to call a software development kit of a third-party application, wherein the target application runs on the platform.

The transmission module 52 is configured to transmit identification information of the target application to the software development kit.

The association module 53 is configured to determine metadata which is required for the third-party application to verify the target application, and establish an association relationship between the metadata and the identification information.

The metadata registering module 54 is configured to register the metadata into a system which the platform resides in so that the third-party application performs verification by obtaining the metadata associated with the identification information according to the association relationship.

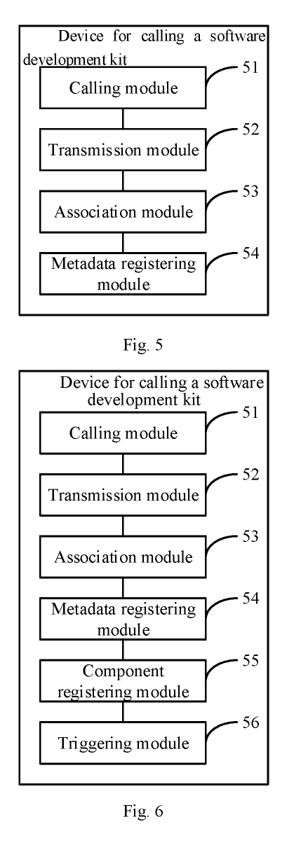

FIG. 6 is a block diagram schematically showing a device for calling a software development kit according to another example. As shown in FIG. 6, on the basis of the example described with reference to FIG. 5, the device further includes a component registering module 55 and a triggering module 56.

The component registering module 55 is configured to register into the system a component which is required for the software development kit to respond to the target application.

The triggering module 56 is configured to, after a running instruction is received from the system, enable the component to run so that a response which is made by the software development kit to the target application is transmitted to the target application by the component.

According to an example, when the metadata registering module registers the metadata into the system which the platform resides in, the component registering module registers the component into the system.

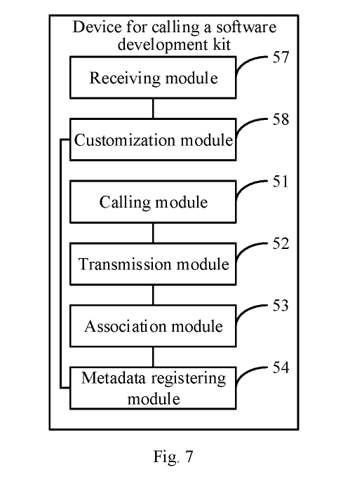

FIG. 7 is a block diagram schematically showing a device for calling a software development kit according to another example. As shown in FIG. 7, on the basis of the example described with reference to FIG. 5, the device further includes a receiving module 57 and a customization module 58.

The receiving module 57 is configured to receive a custom instruction.

The customization module 58 is configured to customize the metadata of the target application according to the custom instruction.

Details about the operations performed by individual modules in the examples of the devices can be found in the descriptions about the examples of the methods and repeated descriptions are omitted.

For the device examples, since they substantially correspond to the method examples, reference can be made to the description of the method examples. The examples described above are merely illustrative, the modules described as separate components may be physically separated or not, and the components shown as modules may be physical modules or not, i.e., these modules can be disposed in the same place, or may be distributed over a plurality of network modules. A part or all of the modules may be selected according to actual needs to achieve the purpose of the present disclosure. One of ordinary skill in the art will understand and practice the present disclosure without paying creative work.

The present disclosure further provides a device for calling a software development kit. The device includes: a processor; and a memory for storing instructions executable by the processor. The processor is configured to: according to a received preset instruction, trigger a target application to call a software development kit of a third-party application, wherein the target application runs on a platform; transmit identification information of the target application to the software development kit; determine metadata which is required for the third-party application to verify the target application, and establish an association relationship between the metadata and the identification information; and register the metadata into a system which the platform resides in so that the third-party application performs verification by obtaining the metadata associated with the identification information according to the association relationship.

The present disclosure also provides a terminal which includes a memory and one or more programs. The one or more programs are stored in the memory, and after being configured, one or more processors cause one or more programs to perform the following steps: according to a received preset instruction, triggering a target application to call a software development kit of a third-party application, wherein the target application runs on the platform; transmitting identification information of the target application to the software development kit; determining metadata which is required for the third-party application to verify the target application, and establishing an association relationship between the metadata and the identification information; and registering the metadata into a system which the platform resides in so that the third-party application performs verification by obtaining the metadata associated with the identification information according to the association relationship.

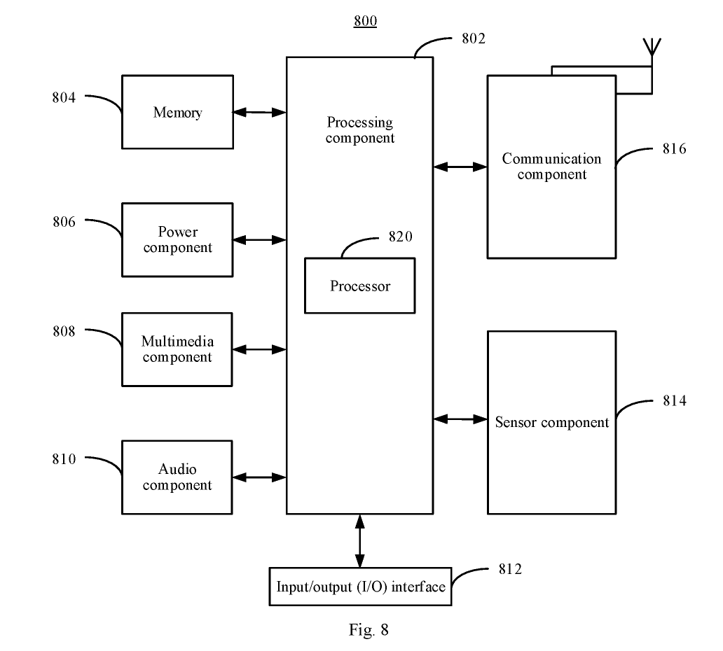

FIG. 8 is a block diagram of a device 800 for calling a software development kit according to an example. For example, the device 800 may be a mobile phone, a computer, a digital broadcast terminal, a messaging device, a gaming console, a tablet, a medical device, exercise equipment, a personal digital assistant, and the like.

Referring to FIG. 8, the device 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any applications or methods operated on the device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 800. The power component 806 may include a power management system, one or more power sources, and any other components associated with the generation, management, and distribution of power in the device 800.

The multimedia component 808 includes a screen providing an output interface between the device 800 and the user. In some examples, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some examples, the multimedia component 808 includes a front camera and/or a rear camera. The front camera and/or the rear camera may receive an external multimedia datum while the device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the device 800 is in an operation mode, such as a call mode, a recording mode, and a voice recognition mode. The received audio signal may be further stored in the memory 804 or transmitted via the communication component 816. In some examples, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the device 800. For instance, the sensor component 814 may detect an open/closed status of the device 800, relative positioning of components, e.g., the display and the keypad, of the device 800, a change in position of the device 800 or a component of the device 800, a presence or absence of user contact with the device 800, an orientation or an acceleration/deceleration of the device 800, and a change in temperature of the device 800. The sensor component 814 may include a proximity sensor configured to detect the presence of nearby objects without any physical contact. The sensor component 814 may also include a light sensor, such as a CMOS or CCD image sensor, for use in imaging applications. In some examples, the sensor component 814 may also include an accelerometer sensor, a gyroscope sensor, a magnetic sensor, a pressure sensor, or a temperature sensor.

The communication component 816 is configured to facilitate communication, wired or wirelessly, between the device 800 and other devices. The device 800 can access a wireless network based on a communication standard, such as WiFi, 2Q or 3Q or a combination thereof. In one example, the communication component 816 receives a broadcast signal or broadcast associated information from an external broadcast management system via a broadcast channel. In one example, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In examples, the device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In examples, there is also provided a non-transitory computer-readable storage medium including instructions, such as the memory 804 including instructions, the above instructions are executable by the processor 820 in the device 800, for performing the above-described methods. For example, the non-transitory computer-readable storage medium may be a ROM, a RAM, a CD-ROM, a magnetic tape, a floppy disc, an optical data storage device, and the like.

The present disclosure provides a method for calling a software development kit, a device for calling a software development kit, an electronic device and a computer-readable storage medium.

According to a first aspect of the examples of the present disclosure, there is provided a method for calling a software development kit, applied in a platform, wherein the method includes:

according to a received preset instruction, triggering a target application to call a software development kit of a third-party application, wherein the target application runs on the platform;

transmitting identification information of the target application to the software development kit;

determining metadata which is required for the third-party application to verify the target application, and establishing an association relationship between the metadata and the identification information; and

registering the metadata into a system which the platform resides in so that the third-party application performs verification by obtaining the metadata associated with the identification information according to the association relationship.

According to an example, the method further includes:

registering into the system a component which is required for the software development kit to respond to the target application; and

after receiving a running instruction from the system, enabling the component to run so that a response which is made by the software development kit to the target application is transmitted to the target application by the component.

According to an example, the registering into the system a component which is required for the software development kit to respond to the target application, includes:

when registering the metadata into the system, registering the component into the system.

According to an example, prior to receiving of the preset instruction, the method further includes:

receiving a custom instruction; and

customizing the metadata of the target application according to the custom instruction.

According to a second aspect of examples of the present disclosure, there is provided a device for calling a software development kit, applied in a platform. The device includes:

a calling module configured to, according to a received preset instruction, trigger a target application to call a software development kit of a third-party application, wherein the target application runs on the platform;

a transmission module configured to transmit identification information of the target application to the software development kit;

an association module configured to determine metadata which is required for the third-party application to verify the target application, and establish an association relationship between the metadata and the identification information; and

a metadata registering module configured to register the metadata into a system which the platform resides in so that the third-party application performs verification by obtaining the metadata associated with the identification information according to the association relationship.

According to an example, the device further includes:

a component registering module configured to register into the system a component which is required for the software development kit to respond to the target application; and

a triggering module configured to, after a running instruction is received from the system, enable the component to run so that a response which is made by the software development kit to the target application is transmitted to the target application by the component.

According to an example, when the metadata registering module registers the metadata into the system which the platform resides in, the component registering module registers the component into the system.

According to an example, the device further includes:

a receiving module configured to receive a custom instruction; and

a customization module configured to customize the metadata of the target application according to the custom instruction.

According to a third aspect of examples of the present disclosure, there is provided an electronic device, including:

a processor; and

a memory for storing instructions executable by the processor;

wherein the processor is configured to:

according to a received preset instruction, trigger a target application to call a software development kit of a third-party application, wherein the target application runs on a platform;

transmit identification information of the target application to the software development kit;

determine metadata which is required for the third-party application to verify the target application, and establish an association relationship between the metadata and the identification information; and

register the metadata into a system which the platform resides in so that the third-party application performs verification by obtaining the metadata associated with the identification information according to the association relationship.

According to a fourth aspect of examples of the present disclosure, there is provided a computer-readable storage medium having stored therein computer programs that, when executed by a processor, implement the following steps:

according to a received preset instruction, triggering a target application to call a software development kit of a third-party application, wherein the target application runs on the platform;

transmitting identification information of the target application to the software development kit;

determining metadata which is required for the third-party application to verify the target application, and establishing an association relationship between the metadata and the identification information; and

registering the metadata into a system which the platform resides in so that the third-party application performs verification by obtaining the metadata associated with the identification information according to the association relationship.

The technical solutions provided by examples of the present disclosure can have the following advantageous effects:

As can be seen from the above examples, depending on varying software development kits of third-party applications and varying target applications, metadata which is required for the software development kits of the third-party applications to verify the target applications is determined, and the determined metadata is registered into a system which a platform resides in. The technical solutions of the present disclosure can ensure that the software development kits of the third-party applications can obtain, from the system, the metadata which is required for verification according to identification information to perform verification and thus the software development kits of the third-party applications can be smoothly called.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors.

Other examples of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only.

It will be appreciated that the present disclosure is not limited to the exact construction that has been described above and illustrated in the accompanying drawings, and that various modifications and changes can be made without departing from the scope thereof.

What is claimed is:

1. A method for calling a software development kit applied in a platform, comprising:
according to a received preset instruction, triggering a target application to call a software development kit of a third-party application, wherein the target application runs on the platform;
transmitting identification information of the target application to the software development kit;
determining metadata which is required for the third-party application to verify the target application, and establishing an association relationship between the metadata and the identification information; and
registering the metadata into a system where the platform is in so that the third-party application performs verification by obtaining the metadata associated with the identification information according to the association relationship.

2. The method according to claim 1, further comprising:
registering into the system a component which is required for the software development kit to respond to the target application; and
after receiving a running instruction from the system, executing the component so that a response which is made by the software development kit to the target application is transmitted to the target application via the component.

3. The method according to claim 2, wherein registering into the system the component which is required for the software development kit to respond to the target application comprises:
when registering the metadata into the system, registering the component into the system.

4. The method according to claim 1, wherein, prior to receiving of the preset instruction, the method further comprises:
receiving a custom instruction; and
customizing the metadata of the target application according to the custom instruction.

5. An electronic device, comprising:
a processor; and
a memory for storing instructions executable by the processor;
wherein the processor is configured to:
according to a received preset instruction, trigger a target application to call a software development kit of a third-party application, wherein the target application runs on the platform;
transmit identification information of the target application to the software development kit;
determine metadata which is required for the third-party application to verify the target application, and establish an association relationship between the metadata and the identification information; and
register the metadata into a system where the platform is in so that the third-party application performs verification by obtaining the metadata associated with the identification information according to the association relationship.

6. The device according to claim 5, wherein the processor is further configured to:
register into the system a component which is required for the software development kit to respond to the target application; and
after a running instruction is received from the system, executing the component so that a response which is made by the software development kit to the target application is transmitted to the target application by the component.

7. The device according to claim 6, wherein the processor is configured to, when the processor is configured to register the metadata into the system where the platform is in, register the component into the system.

8. The device according to claim 5, wherein the processor is further configured to:
receive a custom instruction; and
customize the metadata of the target application according to the custom instruction.

9. A non-transitory computer-readable storage medium having stored therein computer programs that, when executed by a processor, cause the processor to implement:
according to a received preset instruction, triggering a target application to call a software development kit of a third-party application, wherein the target application runs on the platform;
transmitting identification information of the target application to the software development kit;
determining metadata which is required for the third-party application to verify the target application, and establishing an association relationship between the metadata and the identification information; and
registering the metadata into a system where the platform is in so that the third-party application performs verification by obtaining the metadata associated with the identification information according to the association relationship.

10. The non-transitory computer-readable storage medium according to claim 9, wherein the computer programs further cause the processor to implement:
registering into the system a component which is required for the software development kit to respond to the target application; and
after receiving a running instruction from the system, executing the component so that a response which is made by the software development kit to the target application is transmitted to the target application via the component.

11. The non-transitory computer-readable storage medium according to claim 10, wherein the computer programs caused the processor to implement registering into the system the component which is required for the software development kit to respond to the target application further cause the process to implement:
when registering the metadata into the system, registering the component into the system.

12. The non-transitory computer-readable storage medium according to claim 9, wherein, prior to receiving of the preset instruction, the computer programs further cause the processor to implement:
receiving a custom instruction; and
customizing the metadata of the target application according to the custom instruction.
